(19) United States
(12) Patent Application Publication
(10) Pub. No.: US 2012/0131592 A1
(43) Pub. Date: May 24, 2012

(54) PARALLEL COMPUTING METHOD FOR PARTICLE BASED SIMULATION AND APPARATUS THEREOF

(75) Inventors: Young Hee KIM, Daejeon (KR); Soon Hyoung Pyo, Daejeon (KR); Bon Ki Koo, Daejeon (KR)

(73) Assignee: ELECTRONICS AND TELECOMMUNICATIONS RESEARCH INTITUTE, Daejeon (KR)

(21) Appl. No.: 13/296,489

(22) Filed: Nov. 15, 2011

(30) Foreign Application Priority Data
Nov. 18, 2010 (KR) 10-2010-0115183

(51) Int. Cl. G06F 9/46

(52) U.S. Cl. 718/104

(57) ABSTRACT

Disclosed are a parallel computing method for particle based simulation that may decrease a calculation delay due to data communication by simultaneously performing the data communication and a simulation calculation and increasing parallelism of a task, and an apparatus thereof. The parallel computing method for particle based simulation according to an exemplary embodiment to the present invention may include decomposing the whole calculation domain of a manager node into a plurality of sub-domains based on a grid macro-cell based orthogonal recursive bisection (ORB) method; allocating the decomposed sub-domains to worker nodes; and performing load balancing with respect to the worker nodes.

### CROSS-REFERENCE TO RELATED APPLICATIONS

This application claims priority to and the benefit of Korean Patent Application No. 10-2010-0115183 filed in the Korean Intellectual Property Office on Nov. 18, 2010, the entire contents of which are incorporated herein by reference.

### TECHNICAL FIELD

The present invention relates to a parallel computing method for particle based simulation and an apparatus thereof.

### BACKGROUND

In general, most parallel computing methods need a process of sharing information between processors and updating the information and thus, communication between the processors is required. Due to the communication between the processors, actual calculation time is 1/m and does not decrease. Here, m denotes the number of processors.

### SUMMARY

The present invention has been made in an effort to provide a parallel computing method for particle based simulation that may decrease a calculation delay due to data communication by simultaneously performing the data communication and a simulation calculation and increasing parallelism of a task, and an apparatus thereof.

An exemplary embodiment of the present invention provides a parallel computing method for particle based simulation, the method including: decomposing the whole calculation domain of a manager node into a plurality of sub-domains based on a grid macro-cell based orthogonal recursive bisection (ORB) method; allocating the decomposed sub-domains to worker nodes; and performing load balancing with respect to the worker nodes.

The decomposing of the whole calculation domain into the sub-domains may include decomposing the whole calculation domain into the plurality of sub-domains based on the grid macro-cell based ORB method.

The decomposing of the whole calculation domain into the sub-domains may be recursively performed until the number of sub-domains becomes equal to the number of worker nodes.

The decomposing of the whole calculation domain into the sub-domains may include decomposing the whole calculation domain into the sub-domains so that the equivalent number of particles belongs to the sub-domains.

The decomposing of the sub-domains may include decomposing each of the sub-domains based on a y axis.

The performing of the load balancing with respect to the worker nodes may include performing parallel computing of the particle based simulation based on the grid macro-cell based ORB method.

The performing of the load balancing with respect to the worker nodes may include performing the load balancing by combining the grid macro-cell based ORB method with the manager node-worker nodes.

The performing of the load balancing may perform the load balancing through exchanging of particle distribution information of the macro cell and the sub-domains between the manager node and the worker nodes.

The performing of the load balancing with respect to the worker nodes may include separately calculating a domain requiring neighbor particle information and a domain not requiring the neighbor particle information by combining the grid macro-cell based ORB method with the manager node-worker nodes.

The parallel computing method for the particle based simulation may further include paralleling calculation of the domain not requiring the neighbor particle information and exchanging of neighbor particles between the worker nodes.

The performing of the load balancing with respect to the worker nodes may include performing the load balancing in order to decrease a calculation delay in data communication by decreasing an amount of data communication between the worker nodes and by simultaneously performing the data communication and a simulation calculation and increasing parallelism of a task.

Another exemplary embodiment of the present invention provides a parallel computing apparatus for particle based simulation, simultaneously performing data communication and a simulation calculation, the apparatus including: worker nodes to exchange information; and a manager node to decompose the whole calculation domain into a plurality of sub-domains based on a grid macro-cell based ORB method, to allocate the decomposed sub-domains to the operation processors, and to perform load balancing with respect to the operation processors.

Yet another exemplary embodiment of the present invention provides a parallel computing apparatus for particle based simulation, simultaneously performing data communication and a simulation calculation, the apparatus including: worker nodes; and a manager node to decompose the whole calculation domain into a plurality of sub-domains based on a grid macro-cell based ORB method, to allocate the decomposed sub-domains to the worker nodes, and to perform load balancing with respect to the worker nodes. The load balancing may be performed through exchanging of particle distribution information of the macro cell and the sub-domains between the manager node and the worker nodes.

A parallel computing method for particle based simulation and an apparatus thereof according to exemplary embodiments of the present invention may easily configure parallel computing and also improve performance by performing an ORB method based on a grid macro-cell unit, not a particle unit.

A parallel computing method for particle based simulation and an apparatus thereof according to exemplary embodiments of the present invention may perform load balancing only with small data migration and a small calculation amount through a load-balancing method in which a manager-worker system and a grid macro-cell based ORB method are combined.

A parallel computing method for particle based simulation and an apparatus thereof according to exemplary embodiments of the present invention may be applied to particle simulation and thereby perform a parallel simulation in which extensibility is improved in inverse proportion to the number of nodes, by paralleling a sub-domain calculation of each worker node occupying most simulation calculation and exchanging of neighbor particles occupying most data communication between nodes.

A parallel computing method for particle based simulation and an apparatus thereof according to exemplary embodiments of the present invention may broadcast predetermined data to nodes that are probably neighbor nodes, thereby decreasing calculation time without increasing data communication time in a many-to-many connection network, rather than finding a neighbor node for each simulation time step and calculating data to be transmitted to each neighbor node.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a manager-worker node structure according to an exemplary embodiment of the present invention.

FIG. 2 is a diagram illustrating a result of decomposing a domain based on an orthogonal recursive bisection (ORB) method according to an exemplary embodiment of the present invention.

FIG. 3 is a diagram illustrating a calculation domain and a neighbor domain of worker 4 node according to an exemplary embodiment of the present invention.

FIG. 4 is a diagram illustrating calculation time for each task of a manager, a worker, and data communication according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

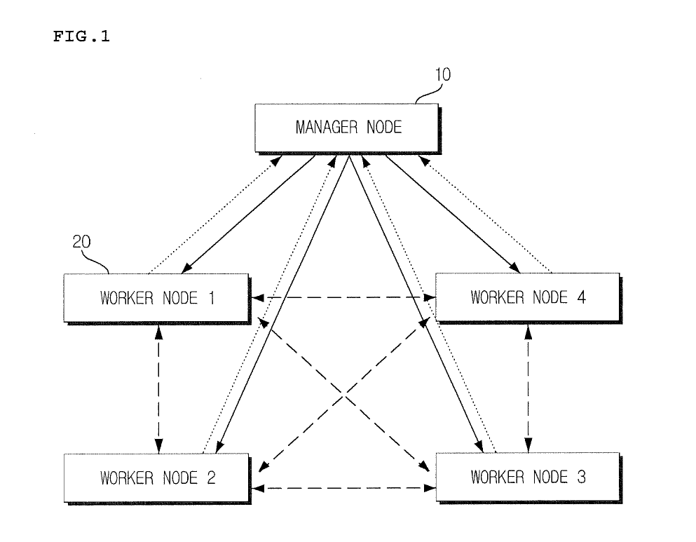

Hereinafter, a parallel computing method for particle based simulation capable of decreasing a calculation delay due to data communication by simultaneously performing the data communication and a simulation calculation and increasing parallelism of a task will be described with reference to FIGS. 1 through 4.

The present invention is conceived to decrease a data communication amount between operation processors for load balancing, and to improve parallelism of a task by simultaneously performing data communication and a simulation calculation, using advantages of a grid macro-cell based orthogonal recursive bisection (ORB) method, thereby enabling parallel computing with high extensibility.

Parallelism is generally classified into two methods: One is a data parallelism method in which a plurality of processors decompose and process data and the other is a task parallelism method in which a plurality of processors decompose and process a task with respect to the same data. The data parallelism method is suitable for the particle based simulation.

Among factors considered to efficiently parallel a simulation using the data parallelism method, two factors are important. One factor to be considered is load balancing of decomposing the whole calculation domain into small sub-domains to equivalently allocate work to operation processors, and maintaining the balance of work allocations as the simulation proceeds, in order to reduce process time in an idle state. This is because a position of a particle changes and migration between processors occurs as the simulation proceeds. The other factor to be considered is to minimize data communication in order to decrease a calculation delay due to data communication between the processors.

FIG. 1 is a diagram illustrating a manager-worker node structure according to an exemplary embodiment of the present invention.

As shown in FIG. 1, distributed operation nodes are connected in the manager-worker node structure. A main role of a manager node 10 is to decompose the whole calculation domain of simulation and thereby allocate the decomposed calculation domains to worker nodes (including operation processors) (e.g., worker 1, worker 2, worker 3, and worker 4) 20, and to maintain load balancing by reflecting environment variation according to progress of the simulation. A main role of the worker node 20 is to perform actual calculation with respect to an allocated calculation domain. In the present invention, a message passing interface (MPI) library is used for exchanging data between worker nodes. The number of worker nodes may be different from the number of operation processors. This is because a plurality of operation processors may operate in a single worker node. The manager node 10 performs parallel computing of the particle based simulation based on the grid macro-cell based ORB method.

The manager node 10 decomposes the whole calculation into a plurality of sub-domains based on the grid macro-cell based ORB method, allocates the decomposed sub-domains to the operation processors (worker nodes), and performs load balancing with respect to the operation processors.

The manager node 10 may decompose the whole calculation domain into the plurality of sub-domains based on the grid macro-cell based ORB method.

The manager node 10 may decompose the whole calculation domain into the sub-domains so that the equivalent number of particles may belong to the sub-domains.

The manager node 10 may decompose the sub-domains based on a y axis with respect to each of the sub-domains

The manager node 10 may perform the load balancing by combining the grid macro-cell based ORB method with the manager node-operation processors (worker nodes).

The manager node 10 may perform the load balancing through exchanging of particle distribution information of the macro cell and the sub-domains between the manager node 10 and the worker nodes 20. The manager node 10 may perform the load balancing in order to decrease a calculation delay due to data communication by decreasing an amount of data communication between the operation processors and simultaneously performing the data communication and a simulation calculation to thereby increase parallelism of a task.

The manager node 10 may separately calculate a domain requiring neighbor particle information and a domain not requiring the neighbor particle information by combining the grid macro-cell based ORB method with the operation processors. The manager node 10 may parallel calculation of the domain not requiring the neighbor particle information and exchanging of neighbor particles between the worker nodes 20.

Hereinafter, the present invention is described based on a node level. When a plurality of processors are present in a single node, a multi-thread using a shared memory is applied.

(1) Domain Decomposition

The present invention employs a grid macro-cell based ORB method. The ORB method generates a separate plane to be separated into a plurality of subspaces in the direction having the largest length measure of space where the entire particles are distributed, and enables particles relatively closely positioned among a large number of particles to constitute a set in the same subspace. Here, the separate plane is determined so that the same number of particles may be positioned in both subspaces. The above process is continuously performed using a recursive method until the number of subspaces decomposed becomes equal to the total number of operation nodes.

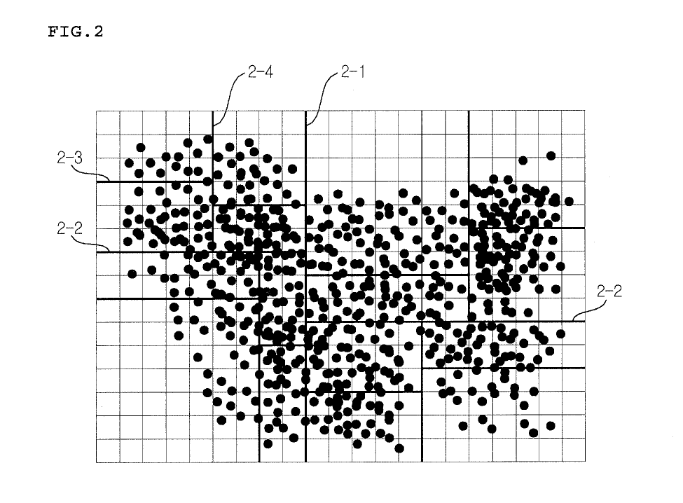

FIG. 2 is a diagram illustrating a result of decomposing a domain based on an ORB method according to an exemplary embodiment of the present invention.

FIG. 2 shows a result of decomposing a two-dimensional (2D) domain based on the grid macro-cell based ORB method employed by the present invention. A domain where particles belong is decomposed based on a grid of an interval used to find neighbor particles in particle interaction processing, and particles belonging to each cell are counted (this step is performed in a simulation calculation step and thus, work load does not increase). Each cell interval is greater than a particle diameter and thus, a plurality of particles may belong to a single cell. When it is assumed that a width is an x axis and a height length is a y axis, the 2D domain is initially decomposed into two sub-domains based on the x axis. Here, the two sub-domains are decomposed so that the equivalent number of particles of cells may belong to each sub-domain (first line 2-1). Each sub-domain is decomposed again into two domains based on the y axis using the same method (second line 2-2). When the above two steps are completed, the 2D domain is decomposed into four sub-domains.

Also, the sub-domains may be additionally decomposed with alternatively changing the axes so that the number of sub-domains corresponding to the number of nodes may be generated (third line 2-3 and fourth line 2-4).

(2) Load Balancing

In the present invention, the manager node 10 calculates only a domain to be allocated to each node according to particle distribution, and particle information is exchanged between the worker nodes 20. The worker node 20 transmits the number of particles belonging to each cell of an allocated domain to the manager node 10 (e.g., a dotted arrow from the worker node 20 to the manager node 10 shown in FIG. 1). The size of data is significantly small compared to position information of particles. In general, in a large simulation, the number of cells is a small value compared to the number of particles and is an integer data value, not a vector data value. The manager node 10 calculates a domain allocated to each node using the same method used for domain decomposition, and broadcasts domain information to the worker node 20 (a solid arrow from the manager node 10 to the worker node 20 shown in FIG. 1). Information of each sub-domain includes only the number of nodes X two vectors as a cell address value corresponding to “left-bottom” and “right-top”.

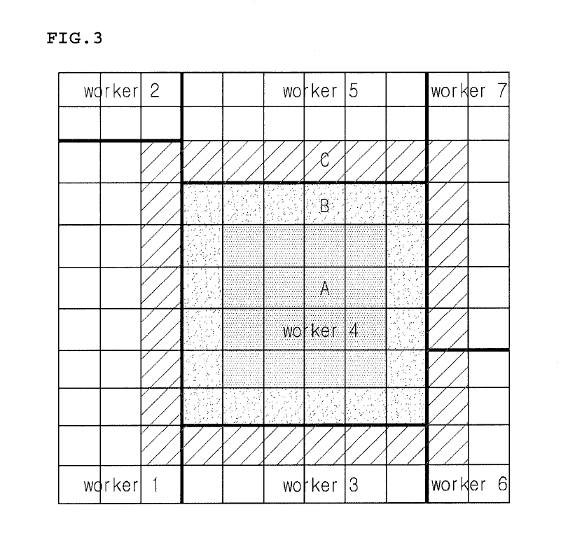

FIG. 3 is a diagram illustrating a calculation domain and a neighbor domain of worker 4 node according to an exemplary embodiment of the present invention.

(3) Data Exchanging Between Worker Nodes 20

The worker nodes 20 exchange particle data based on domain information that is received from the manager node 10 after load balancing (a dotted arrow between the worker nodes 20 shown in FIG. 1). The data exchanging is classified into two schemes based on data communicating. One is to transmit, to a corresponding node, particle information that does not belong to a domain of the worker node 20 any more as a domain of which the worker node 20 takes charge varies, and to receive particle information transmitted from another node (worker 4 of FIG. 3 transmits and receives information to and from A domain in order to secure B domain-information). The other is to transmit and receive neighbor particle information belonging to a neighbor node that is required for particle interaction calculation (worker 4 of FIG. 3 transmits and receives information to and from neighbor nodes to secure C domain-information).

The shape of a decomposed sub-domain continuously changes as the simulation proceeds. Accordingly, to calculate which data is to be transmitted to which neighbor node every time, it generates large calculation load. In the present invention, data is transmitted to all neighbor nodes that can adjoin each node. The structure in which all nodes exchange data with a plurality of nodes in many-to-many connection does not greatly affect the performance. The adjoin-able nodes are determined in an initial stage of the simulation and are stored in a table and thereby are used.

To minimize a calculation delay due to data exchanging, the present invention decomposes the aforementioned two types of data exchanging into the following four steps and thereby performs the data exchanging.

Step 1: In FIG. 3, “worker 4” exchanges data with a neighbor node in order to have all particle information corresponding to A domain and B domain. Data migration occurs only when a change occurs in a domain.

Step 2: A calculation is performed with respect to A domain. The calculation of A domain does not require data of C domain.

Step 3: Data of C domain is received from a neighbor node. Data is exchanged every simulation time step.

Step 4: Calculation of B domain is performed.

When steps are performed as above, steps 2 and 3 are simultaneously performed. In general, A domain is significantly large compared to C domain and thus, a delay due to data exchanging decreases. Also, step 1 is not performed every time step, whereas step 3 is performed every time step. Therefore, further great data exchanging by step 3 occurs. Since step 3 proceeds while the calculation is being performed, the calculation delay due to data exchange may significantly decrease in the entire simulation.

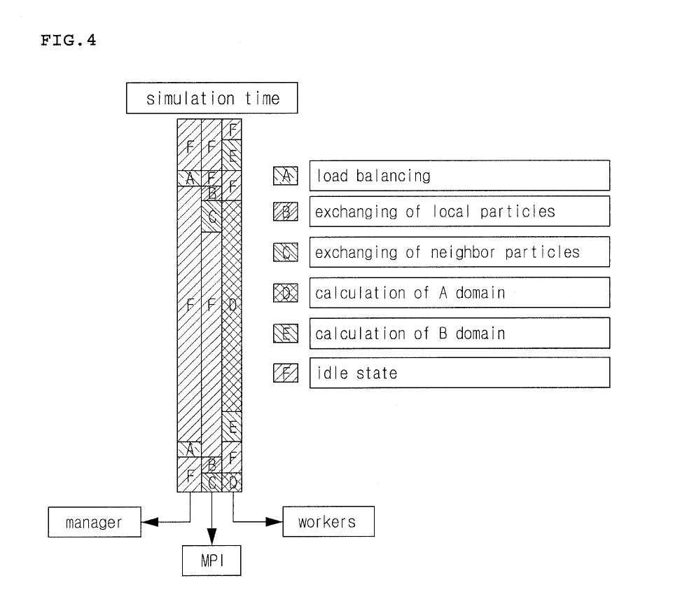

FIG. 4 is a diagram illustrating calculation time for each task of a manager, a worker, and data communication according to an exemplary embodiment of the present invention.

As shown in FIG. 4, a left bar graph shows time used for each task of a manager node and a right bar graph shows time used for each task of worker nodes.

A middle bar graph disposed between the left bar graph and the right bar graph shows time used for exchanging data. As shown in FIG. 4, load occurring when performing parallel computing according to an exemplary embodiment of the present invention corresponds to an A bar graph of the manager node and a B bar graph of data exchanging. This is relatively small compared to the entire calculation.

The present invention shows the high class extensibility in which calculation time decreases in inverse proportion to the number of processors used in a simulation when performing the particle based simulation in a distribution computing environment. When using a multi-processor, the simulation calculation is simultaneously distributed and thereby is performed in a plurality of processors and thus, the calculation time decreases. However, most parallel computing methods need a process of sharing information between processors and updating the information and thus, communication between the processors is required. Due to the communication between the processors, actual calculation time is 1/m and does not decrease. Here, m denotes the number of processors. On the contrary, the present invention may decrease an amount of data communication between processors using a grid macro-cell based ORB method and decrease a calculation delay due to data communication by simultaneously performing the data communication and a simulation calculation and increasing parallelism of a task. Accordingly, parallel computing with high extensibility is enabled.

As described above, a parallel computing method for particle based simulation and an apparatus thereof according to exemplary embodiments of the present invention may easily configure parallel computing and also improve performance by performing an ORB method based on a grid macro-cell unit, not a particle unit.

A parallel computing method for particle based simulation and an apparatus thereof according to exemplary embodiments of the present invention may perform load balancing only with small data migration and a small calculation amount through a load-balancing method in which a manager-worker system and a grid macro-cell based ORB method are combined.

A parallel computing method for particle based simulation and an apparatus thereof according to exemplary embodiments of the present invention may be applied to particle simulation and thereby perform a parallel simulation in which extensibility is improved in inverse proportion to the number of nodes by paralleling a sub-domain calculation of each worker node occupying most simulation calculation and exchanging of neighbor particles occupying most data communication between nodes.

A parallel computing method for particle based simulation and an apparatus thereof according to exemplary embodiments of the present invention may broadcast predetermined data to nodes that are probably neighbor nodes, thereby decreasing calculation time without increasing data communication time in a many-to-many connection network, rather than finding a neighbor node for each simulation time step and calculating data to be transmitted to each neighbor node.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A parallel computing method for particle based simulation, the method comprising:
decomposing the whole calculation domain of a manager node into a plurality of sub-domains based on a grid macro-cell based orthogonal recursive bisection (ORB) method;
allocating the decomposed sub-domains to worker nodes; and
performing load balancing with respect to the worker nodes.

2. The method of claim 1, wherein the decomposing of the whole calculation domain into the sub-domains comprises:
decomposing the whole calculation domain into the plurality of sub-domains based on the grid macro-cell based ORB method; and
decomposing the sub-domains based on the grid macro-cell based ORB method.

3. The method of claim 1, wherein the decomposing of the whole calculation domain into the sub-domains comprises decomposing the whole calculation domain into the sub-domains so that the equivalent number of particles belongs to the sub-domains.

4. The method of claim 2, wherein the decomposing of the sub-domains comprises decomposing each of the sub-domains based on a y axis.

5. The method of claim 1, wherein the performing of the load balancing with respect to the worker nodes comprises performing parallel computing of the particle based simulation based on the grid macro-cell based ORB method.

6. The method of claim 1, wherein the performing of the load balancing with respect to the worker nodes comprises performing the load balancing by combining the grid macro-cell based ORB method with the manager node-worker nodes.

7. The method of claim 6, wherein the performing of the load balancing comprises performing the load balancing through exchanging of particle distribution information of the macro cell and the sub-domains between the manager node and the worker nodes.

8. The method of claim 1, wherein the performing of the load balancing with respect to the worker nodes comprises separately calculating a domain requiring neighbor particle information and a domain not requiring the neighbor particle information by combining the grid macro-cell based ORB method with the manager node-worker nodes.

9. The method of claim 8, further comprising:
paralleling calculation of the domain not requiring the neighbor particle information and exchanging of neighbor particles between the worker nodes.

10. The method of claim 1, wherein the performing of the load balancing with respect to the worker nodes is performing the load balancing in order to decrease a calculation delay due to data communication by decreasing an amount of data communication between the worker nodes and by simultaneously performing the data communication and a simulation calculation and increasing parallelism of a task.

11. A parallel computing apparatus for particle based simulation, simultaneously performing data communication and a simulation calculation, the apparatus comprising:
worker nodes to exchange information; and
a manager node to decompose the whole calculation domain into a plurality of sub-domains based on a grid macro-cell based ORB method, to allocate the decomposed sub-domains to the worker nodes, and to perform load balancing with respect to the worker nodes.

12. The apparatus of claim 11, wherein the manager node decomposes the whole calculation domain into the plurality of sub-domains based on the grid macro-cell based ORB method, and decomposes the sub-domains based on the grid macro-cell based ORB method.

13. The apparatus of claim 12, wherein the manager node decomposes the whole calculation domain into the sub-domains so that the equivalent number of particles belongs to the sub-domains.

14. The apparatus of claim 12, wherein the manager node decomposes each of the sub-domains based on a y axis.

15. The apparatus of claim 11, wherein the manager node performs parallel computing of the particle based simulation based on the grid macro-cell based ORB method.

16. The apparatus of claim 11, wherein the manager node performs the load balancing by combining the grid macro-cell based ORB method with the manager node-worker nodes.

17. A parallel computing apparatus for particle based simulation, simultaneously performing data communication and a simulation calculation, the apparatus comprising:
worker nodes; and
a manager node to decompose the whole calculation domain into a plurality of sub-domains based on a grid macro-cell based ORB method, to allocate the decomposed sub-domains to the worker nodes, and to perform load balancing with respect to the worker nodes,
wherein the load balancing is performed through exchanging of particle distribution information of the macro cell and the sub-domains between the manager node and the worker nodes.
